(19) United States
(12) Patent Application Publication
(10) Pub. No.: US 2010/0133087 A1
(43) Pub. Date: Jun. 3, 2010

(54) Method for Treating Water

(76) Inventor: Larry Presley, Henderson, NV (US)

Correspondence Address: GREENBERG & LIEBERMAN, LLC, 2141 WISCONSIN AVE, N.W., SUITE C-2, WASHINGTON, DC, 20007, US

(21) Appl. No.: 12/128,037

(22) Filed: May 28, 2008

(51) Int. Cl. B01D 53/00

(52) U.S. Cl. 204/157.3

(57) ABSTRACT

A hollow cylindrical tube runs the length of a photo-reactor plate. The tube is positioned below the photo-reactor plate or the photo-reactor plate sits atop the device. The cylindrical tube has a slotted opening on top. The photo-reactor plate fits into the slotted opening and is supported by the slotted opening. There is added reinforcement through the use of support braces on either side of the slotted opening along the cylindrical tube. These support braces are L-shaped and add strength and support to the upright plates sitting in the slotted opening. The support braces are aid in the attachment of the cylindrical tubing and the photo-reactor plates. The photo-reactor plates contain UV light once UV light has entered. Other parts of the present invention can be manufactured to contain UV light once UV light has entered, as well.

### FIELD OF THE INVENTION

The present invention relates to treating water, specifically to neutralizing toxic waste water; and more particularly, to effectively containing ultraviolet light within a photo-reactor plate to completely destroy any organic compound in the waste water.

### BACKGROUND OF THE INVENTION

Many companies and industries produce or use chemicals that are detrimental to the environment if released into the water systems or air without proper treatment. In the United States, we have series of environmental restrictions that require businesses to catalogue, diffuse and treat the volatile organic compound laden waste water before it is released into the environment, and is such restrictions are regulated by the Environmental Protection Agency. The use of photo-catalysis in volatile organic compound laden waste water management can alter the waste and erradicate it before the water reintroduction to the environment.

It is important to realize that sewage water can be cleaned in a variety of fashions, and the present invention is unconcerned with treating sewage water. Once sewage water has been treated, however, there is a need to remove harmful organic compounds and odors that still remain even after the sewage water has been effectively treated. When sewage water has been effectively treated, it is termed “waste water.” There is no effective method to eradicate organic compounds and odors from treated sewage waste water and volatile organic compound laden waste water.

A large problem throughout industrialization has been waste management. Heavy reliance throughout the years on pesticides and chemicals in agriculture and many other industries have caused industries and communities throughout the country to struggle with the treatment of volatile organic compound laden waste water. Processing volatile organic compound laden waste water in an environmentally sound and economical manner is of concern to many organizations. Photo-catalysis is a well known scientific process with a promising application in volatile organic compound laden waste water management. Photo-catalysis involves bombarding a photo-reactive compound with ultraviolet light. The compound becomes highly reactive; solar energy is converted into chemical energy through the transformation of the photo-reactive compound into reactive radicals. The highly reactive radicals attack oxidizable water pollutants by breaking their molecular bonds. Non toxic final products like water, carbon dioxide and weak acids are the end result.

There exists no method to eradicate organic compounds and odors that is cost effective, as well as that employs an apparatus that is sturdy enough to exist in hostile weather conditions.

Therefore a need has been established for a method to accomplish volatile organic compound laden waste water treatment via photocatalysis such that ultraviolet light is employed to destroy volatile organic compounds.

### SUMMARY OF THE INVENTION

A method for utilizing photo-catalysis in volatile organic compound laden waste water management is through the use of titanium dioxide as a photo-catalyst. Titanium dioxide is mixed in with the volatile organic compound laden waste water. This solution is processed through a series of flat photo-reactor plates. For optimum use of the photo-reactor plates, the solution should be evenly distributed over the flat photo-reactor plates. This would maximize the amount of solution in contact with the flat photo-reactor plates. To distribute the incoming solution from a piped source to the rectangular photo-reactors, an intermediary device is required. In the present invention, an intake flow of volatile organic compound laden waste water is channeled to photo-reactor plates, and the photo-reactor plates are made of a special compound to allow ultraviolet light to be retained to a great extent within the photo-reactor plates.

### Definitions:

Photo-catalysis—to increase the rate of a chemical reaction induced by material unchanged chemically at the end of the reaction with ultra violet light as the energy source for the reaction
photo-catalyst—an agent which provokes or speeds up a reaction with ultra violet light as the energy source to activate the agent
photo-reactor—a device which creates a photochemical reaction
polymerizable—a chemical reaction in which two or more molecules combine to form larger molecules that contain repeating structural units

The present invention is a method that employs a hollow cylindrical tube. The cylindrical tube runs the length of a photo-reactor plate. The tube is positioned below the photo-reactor plate or the photo-reactor plate sits atop the device. The cylindrical tube has a slotted opening on top. The photo-reactor plate fits into the slotted opening and is supported by the slotted opening. There is added reinforcement through the use of support braces on either side of the slotted opening along the cylindrical tube. These L-shaped braces add strength and support to the upright plates sitting in the slotted opening. The L-shaped braces aid in attachment of the cylindrical tubing and the photo-reactor plates.

Since fluids flow through the cylindrical tubing and the photo-reactor plates, a water tight seal is necessary between the tubing and the plates. A polymerizable cement and solvent is used in the slotted opening of the cylindrical tubing. This helps to create a water tight seal between the cylindrical tubing and the photo-reactor plates. The braces attached to the cylindrical tubing and the photo-reactor plates also help in creating a seal. With a water tight connection, fluid can flow through the tubing without contaminating the surrounding area.

Volatile organic compound laden waste water enters the cylindrical tubing from a piped source. One end of the cylindrical tube connects to this piped intake source. The volatile organic compound laden waste water flows through the cylindrical tube and fills the photo-reactor plates. The other end of the cylindrical tube acts as a blind end when plugged or can be hooked up in series with other tubing. A manifold at the top of the photo-reactor plates redistributes the processed water.

Accordingly, it is the object of the present invention to provide a system to optimize removal of toxins and volatile compounds from volatile organic compound laden waste water, and to do so via fluid flow to photo-reactor plates. Ultraviolet light is trapped in the photo-reactor plates so that toxins and volatile compounds can be eradicated.

### BRIEF DESCRIPTION OF THE DRAWING(S)

FIG. 1 shows a cut away side view of the present invention.

FIG. 2 shows a top view of the manifold.

FIG. 3 shows a cut away section of the photo-reflector plate inserted into the manifold.

FIG. 4 is a flowchart of the process of the present invention

### DETAILED DESCRIPTION OF THE PREFERRED EMBODIMENT

Photo-catalysis is a process which occurs when an aqueous solution containing a hydrocarbon compound and a photo-catalyst agent such as titanium dioxide is exposed to ultraviolet rays. When the ultraviolet rays strike the titanium dioxide hydroxyl radicals are produced. The hydroxyl radicals interact with the hydrocarbons to produce carbon dioxide, water, and hydrochloric acid. Therefore, the photo-catalyst can break down volatile organic compound laden waste water into, benign, or recyclable compounds. In the present invention, chemical laden waste water is neutralized by use of a photo-reactor plate (50) and a photo-catalyst (not shown), and most importantly, the photo-reactor plate (50) allows ultraviolet light within it, but then traps the ultraviolet light so that the ultraviolet light is harnessed to destroy undesirable organic compounds.

The present invention is a method to not only direct the intake flow of volatile chemical laden waste water to a photo-reactor plate (50), but moreover, the present invention employs a photo-reactor plate (50) that traps ultraviolet light. The present invention is, in its preferred embodiment, a method that has uses a cylindrical tube manifold (10) that is hollow. Along the apex of the tube is a slotted opening (30). A photo-reactive plate (50) sits in this slotted opening (30). Along the right side of the slotted opening (30) are supporting braces (35). The supporting braces are L-shaped. In the present invention, volatile chemical laden waste water is neutralized by use of the photo-reactor plate (50) and the photo-catalyst. The volatile chemical laden waste water is channeled into the photo-reactor plate (50) where the photo-catalyst and ultraviolet waves break down the volatile organic compound laden waste water. It is important to recognize that if the photo-reactor plate (50) allows much ultraviolet light to escape, or to literally pass through it, then the present invention will not function properly, and will not effectively eradicate volatile chemical laden waste water. Thus, the photo-reactor plate (50) must retain most ultraviolet light within it, and not permit most of the ultraviolet light to leave.

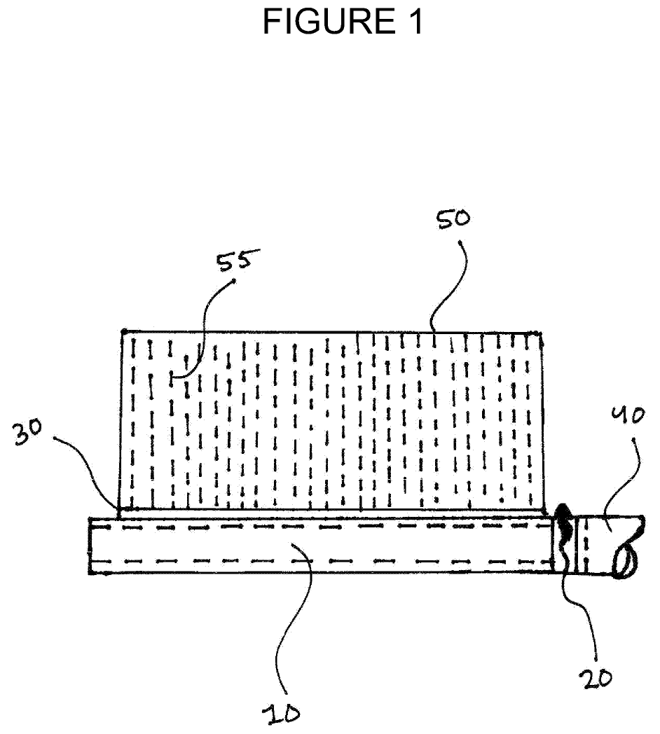

FIG. 1 shows a cut away side view of a possible embodiment of a structure to carry out the present invention. The manifold (10) is manufactured of an impact-modified acrylic (polymethyl methacrylate) polymer sheet, which is a double skinned acrylic sheet that is approximately 1200 mm wide. Such an acrylic sheet assists in maintaining even flow distribution through the channels (55) as shown. The photo-reactor plate (50) of the structure to carry out present invention is also made of an impact-modified acrylic (polymethyl methacrylate) polymer sheet, which is a double skinned acrylic sheet that is approximately 1200 mm wide. Also the skin of the acrylic sheeting is so thin that the majority of UV radiation passes through the skin, and reacts with the titanium dioxide in the solution in the manifold (10) and photo-reactor plate (50), but the UV radiation cannot leave the manifold (10) and/or the photo-reactor plate (50). A 30 weight percentage cement is used to seal the sheet to the manifold. At the end of the manifold (10) is a hose clamp (20) and flexible tubing (40).

The manifold (10) attaches to both ends of the acrylic sheet. More flexible tubing or a cap (45), depending on desired use, can be positioned at the opposite end of the manifold (10) from the flexible tubing (40). If the use of more than one of the structure to carry out the present invention is desired, flexible tubing (40) will be attached to both ends and connected with one another. Cap (45) will only be used at the end of the last of a series of the structures to carry out the present invention if the structures to carry out the present invention is connected in a series so that one structure to carry out the present invention is connected to another structure to carry out the present invention and so forth.

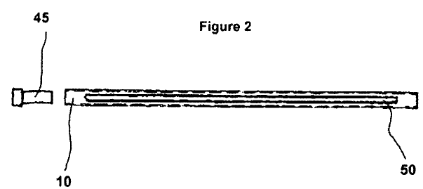

FIG. 2 shows a top view of the manifold and shows cap (45). Cap (45) has a notch (47) in it. Notch (47) lines up directly with slotted opening (30) and is for the photo-reflector plate (50) to sit in when cap (45) is inserted into manifold (10).

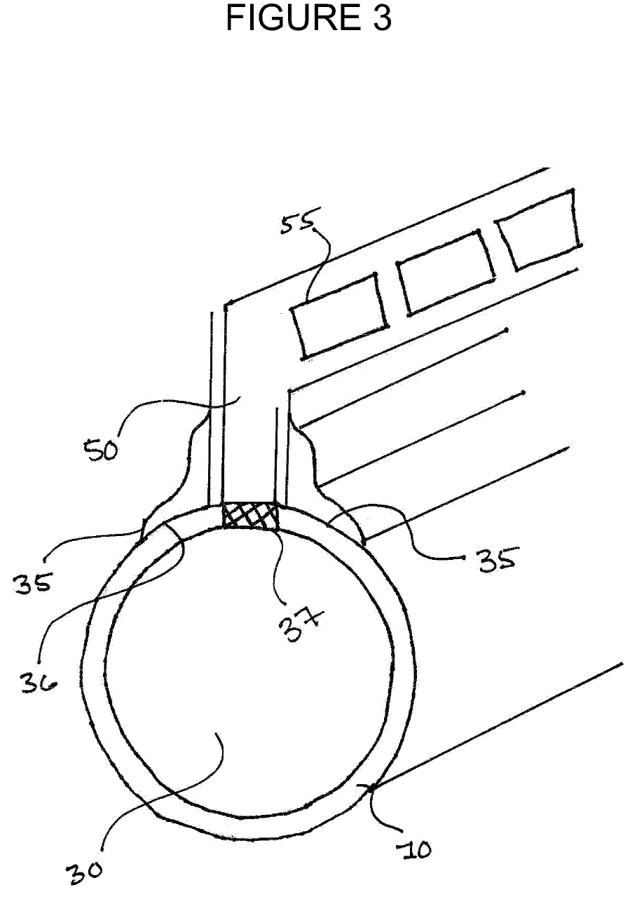

FIG. 3 displays the photo-reactor plate (50) seated in the slotted opening (30) in manifold (10). Support braces (35) are also shown attached to the manifold (10) and the photo-reactor plate (50). At the top of photo-reactor plate (50) is a closer view of the channels (55).

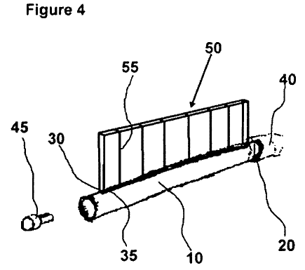

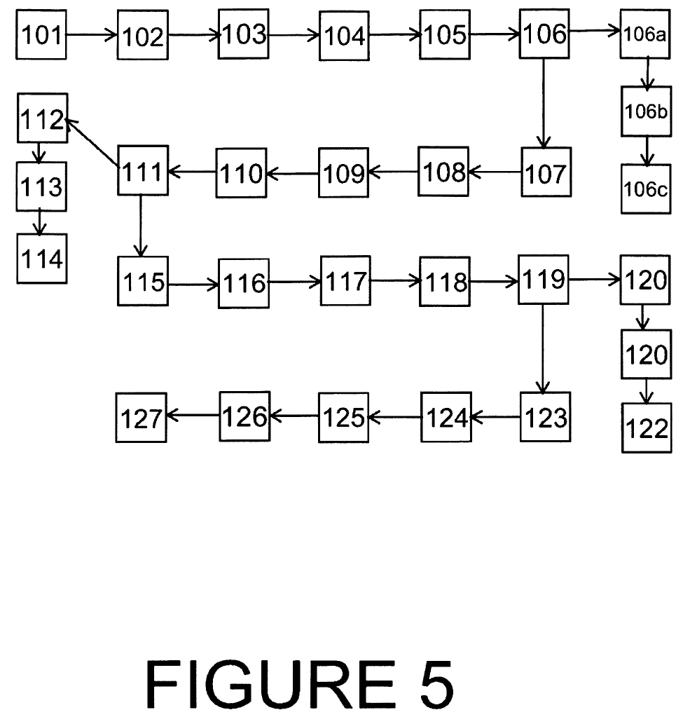

FIG. 4 shows the structure to carry out the present invention and the steps for assembling such. The manifold (10) is shown at an approximate length of 54″. There is a cut away of each end of the manifold member of approximately 3″. There is a cap (45) shown that can attach to one end of the structure to carry out the present invention. Cap (45) is made of a polyurethane material and is then inserted in the interior of the manifold (10), and in this embodiment is 6″ long. Around the center of the flexible tubing (40) is a groove of approximately 17 mm. There is a cement support at 3 and 47 inches to secure the manifold (10). The photo-reactor plate (50) is then inserted in one end of the pipe fashioned as a slot opening (30). This slot opening (30) acts as a flow header into the manifold (10). The end with the photo-reactor plate (50) is then cemented and welded.

The first side (36) of a supporting brace (35) is attached to the manifold (10). The second side (37) of a supporting brace (35) rests on the wall of the photo-reactor plate (50) once the plate (50) is placed in the slot opening (30) and is then welded in place. This procedure is mirrored on both sides of the photo-reactor plate (50). A suitable solvent and polymerized cement provide additional strength at this joint and a water tight seal between the surfaces. The supporting braces (35) are attached to the exterior of the manifold (10) so as to support and prevent damage to the photoreactive plate (50). The photo-reactor plate (50) is disposed above the manifold (10), and the support stresses and demands are different than a typical cylinder upon a cylinder. In addition, in the structure to carry out the present invention, part of the photo-reactor plate (50) fits within a slotted opening (30) atop the manifold (10)—there is a generally rectangular slotted opening (30) to receive the photo-reactor plate (50) in the manifold (10). The fitting of the photo reactor plate (50) in the slotted opening (30) adds to stability of the photo-reactive plate (50).

Volatile organic compound laden waste water from a piped in source enters the first end of the manifold (10) at a rate of 5 gpm. The first end of the manifold (10) fits the end of the piped source through standard piping connectors. The first end of the manifold (10) acts as a conduit for the volatile organic compound laden waste water. The volatile organic compound laden waste water can fill the photo-reactor plates (50). The preferable interior thickness of the photo-reactor plates is ⅝″ and such dimensions allow for approximately up to 150 GPM volume between the photo-reactor plates (50). The first end of the manifold (10) acts as the intake point for volatile organic compound laden waste water to the system. The flow of volatile organic waste water can be slowed by a computer monitor that is conventional and utilizes sensors in the preferred embodiment. For example, should it be desirable to keep the volatile organic waste water inside photo-reactor plates (50) for more than just 150 GPM then the rate of flow can be adjusted by the computer monitor. The preferable rate of flow through the photo-reactor plates (50) is 50 GPM.

Titanium dioxide is initially added to the volatile organic compound laden waste water when the volatile organic compound laden waste water is above EPA standards. The preferable initial amount of titanium dioxide added is from 1 kilo to no more than 10 kilos per 1000 gallons.

The second end of the manifold (10) can be plugged with cap (45) or joined in a series with flexible tubing (40). The computer monitor is used to test the liquid flowing out of the photo-reactor plates (50). A reading of EPA standards above 65 ppb or below will allow the liquid to be channeled back into the ground. A reading of above 65 ppb will force the liquid via a conventional computer pump to return to the processing tank and thus, return for another pass through the photo-reactor plates (50). Titanium dioxide is not added if at a certain EPA standard. Titanium dioxide is added if way above EPA standards.

A third pass through the photo-reactor plates (50) will occur if the liquid leaving the photo-reactor plates (50) has a reading of above EPA standards. For the third pass, Titanium dioxide is added if needed in 1-2 kilos per 1000 gallons amount. If a fourth pass is necessary because liquid leaving the photo-reactor plates (50) has a reading of above EPA standards. For the fourth pass, Titanium dioxide is added if needed and indicated by the conventional computer monitor, in 1-2 kilos per 1000 gallons amount.

For subsequent passes, Titanium dioxide is added if the computer monitor indicates it is above EPA standards; where subsequent passes would be necessary if liquid leaving the photo-reactor plates (50) has a reading of above EPA standards.
The present invention is a method of neutralizing volatile organic compound laden waste water and destroying organic compounds. These organic compounds can include bacteria and other unwanted items. The first step as we see in the flow chart of FIG. 4 comprises piping volatile organic compound laden waste water into a first end of a manifold (101) at a rate of 50 gallons per minute. Second, at least 1 kilo and no more than 10 kilo per 1000 gallons of titanium dioxide is added to the volatile organic compound laden waste water (102). The third step comprises of flowing the volatile organic compound laden waste water from the manifold to a ⅝ inch wide space between 4 foot by 8 foot photo-reactor plates (103), at a rate of up to 150 gallons per minute. The fourth step then comprises slowing and increasing volatile organic compound laden waste water flow between the photo-reactor plates (104) by a computer monitor where fifth, testing liquid flowing out of the photo-reactor plates (105) occurs. It should be noted that the volatile organic compound laden waste water is also referred to as liquid because it might well be rendered to not be volatile organic compound laden waste water. Sixth comprises channeling the liquid flowing out of the photo-reactor plates into ground (106) if the liquid flowing out of the photo-reactor plates is below 65 parts per billion of organic compounds (106a), pumping the liquid out of the photo-reactor plates into a processing tank if the liquid out of the photo-reactor plates is above 65 parts per billion of organic compounds (106b), and channeling the liquid flowing out of the photo-reactor plates into ground if the liquid flowing out of the photo-reactor plates is 65 parts per billion of organic compounds (106c). Seventh is comprised of piping the liquid into the first end of the manifold (107) at a rate of 50 gallons per minute while eighth means adding no titanium dioxide to the liquid (108). Ninth consists of flowing the liquid from the manifold to the ⅝-inch wide space between the photo-reactor plates (109), at a rate of up to 150 gallons per minute while tenth involves slowing and increasing liquid flow (110) between the photo-reactor plates by the computer monitor. The eleventh step involves testing the liquid flowing out of the photo-reactor plates (111). Twelfth relates to channeling the liquid flowing out of the photo-reactor plates into the ground if the liquid flowing out of the photo-reactor plates is below 65 parts per billion of organic compounds (112). Thirteenth involves pumping the liquid out of the photo-reactor plates into the processing tank if the liquid out of the photo-reactor plates is above 65 parts per billion of organic compounds (113) and fourteenth relates to channeling the liquid flowing out of the photo-reactor plates into ground if the liquid flowing out of the photo-reactor plates is 65 parts per billion of organic compounds (114). Fifteenth then requires piping the liquid into the first end of the manifold (115) at a rate of 50 gallons per minute while sixteenth consists of adding 1-2 kilos per 1000 gallons of titanium dioxide (116) to the liquid. Seventeenth then relates to flowing the liquid from the manifold to the ⅝ inch wide space between the photo-reactor plates (117), at a rate of up to 150 gallons per minute while eighteenth involves slowing and increasing liquid flow between the photo-reactor plates (118) by the computer monitor, and nineteenth requires testing the liquid flowing out of the photo-reactor plates (119). The twentieth step relates to channeling the liquid flowing out of the photo-reactor plates into the ground if the liquid flowing out of the photo-reactor plates is below 65 parts per billion of organic compounds (120). The twenty-first meanwhile involves pumping the liquid out of the photo-reactor plates into the processing tank if the liquid out of the photo-reactor plates is above 65 parts per billion of organic compounds (121) and the twenty-second relates to channeling the liquid flowing out of the photo-reactor plates into ground if the liquid flowing out of the photo-reactor plates is 65 parts per billion of organic compounds (122). The twenty-third step requires piping the liquid into the first end of the manifold (123) at a rate of 50 gallons per minute while at twenty-fourth adding no titanium dioxide to the liquid (124). Twenty-fifth involves flowing the liquid from the manifold (125) to the ⅝ inch wide space between the photo-reactor plates, at a rate of up to 150 gallons per minute, twenty-sixth is slowing and increasing liquid flow between the photo-reactor plates (126) by the computer monitor, and twenty-seventh again relates to testing the liquid flowing out of the photo-reactor plates (127). In addition, a second end of the manifold is plugged with a cap. Meanwhile, multiple manifolds are joined in a series with flexible tubing. It also should be noted that another step involves flowing the volatile organic compound laden waste water from the ⅝ inch wide space between the photo-reactor plates, at a rate of up to 150 gallons per minute, to a series of additional ⅝ inch wide spaces between additional 4 foot by 8 foot photo-reactor plates. Testing of the volatile organic compound laden waste water as the volatile organic compound laden waste water moves between the photo-reactor plates also occurs.

It is to be understood that the present invention is not limited to the sole embodiment described above, but should be interpreted in cover all embodiments within the scope of the following claims.

1. A method of neutralizing volatile organic compound laden waste water and destroying organic compounds, comprising:
first, piping volatile organic compound laden waste water into a first end of a manifold at a rate of 50 gallons per minute;
second adding at least 1 kilo and no more than 10 kilo per 1000 gallons of titanium dioxide to the volatile organic compound laden waste water;
third, flowing the volatile organic compound laden waste water from the manifold to a ⅝ inch wide space between 4 foot by 8 foot photo-reactor plates, at a rate of up to 150 gallons per minute;
fourth, slowing and increasing volatile organic compound laden waste water flow between the photo-reactor plates by a computer monitor; and
fifth, testing liquid flowing out of the photo-reactor plates.

2. The method of claim 1, further comprising sixth, channeling the liquid flowing out of the photo-reactor plates into ground if the liquid flowing out of the photo-reactor plates is below 65 parts per billion of organic compounds.

3. The method of claim 1, further comprising sixth, pumping the liquid out of the photo-reactor plates into a processing tank if the liquid out of the photo-reactor plates is above 65 parts per billion of organic compounds.

4. The method of claim 1, further comprising sixth, channeling the liquid flowing out of the photo-reactor plates into ground if the liquid flowing out of the photo-reactor plates is 65 parts or fewer per billion of organic compounds.

5. The method of claim 3, further comprising:
seventh, piping the liquid into the first end of the manifold at a rate of 50 gallons per minute;
eighth, adding no titanium dioxide to the liquid, when testing has shown that adding titanium dioxide is not needed, and adding one to two kilograms of titanium dioxide to the liquid when testing has shown that it is needed;
ninth, flowing the liquid from the manifold to the ⅝ inch wide space between the photo-reactor plates, at a rate of up to 150 gallons per minute;
tenth, slowing and increasing liquid flow between the photo-reactor plates by the computer monitor; and
eleventh, testing the liquid flowing out of the photo-reactor plates.

6. The method of claim 5, further comprising:
twelfth, channeling the liquid flowing out of the photo-reactor plates into the ground when the liquid flowing out of the photo-reactor plates is below 65 parts per billion of organic compounds;
thirteenth, pumping the liquid out of the photo-reactor plates into the processing tank when the liquid out of the photo-reactor plates is above 65 parts per billion of organic compounds; and
fourteenth, channeling the liquid flowing out of the photo-reactor plates into the ground when the liquid flowing out of the photo-reactor plates is 65 parts per billion of organic compounds.

7. The method of claim 6, further comprising:
fifteenth, piping the liquid into the first end of the manifold at a rate of 50 gallons per minute;
sixthteenth, adding 1-2 kilos per 1000 gallons of titanium dioxide to the liquid, when testing has shown that adding titanium dioxide is needed, and adding no titanium dioxide to the liquid when testing has shown that it is not needed;
seventeenth, flowing the liquid from the manifold to the ⅝ inch wide space between the photo-reactor plates, at a rate of up to 150 gallons per minute;
eighteenth, slowing and increasing liquid flow between the photo-reactor plates by the computer monitor; and
nineteenth, testing the liquid flowing out of the photo-reactor plates.

8. The method of claim 7, further comprising:
twentieth, channeling the liquid flowing out of the photo-reactor plates into the ground if the liquid flowing out of the photo-reactor plates is below 65 parts per billion of organic compounds;
twenty-first, pumping the liquid out of the photo-reactor plates into the processing tank if the liquid out of the photo-reactor plates is above 65 parts per billion of organic compounds; and
twenty-second, channeling the liquid flowing out of the photo-reactor plates into ground if the liquid flowing out of the photo-reactor plates is 65 parts per billion of organic compounds.

9. The method of claim 8, further comprising:
twenty-third, piping the liquid into the first end of the manifold at a rate of 50 gallons per minute;
twenty-fourth, adding no titanium dioxide to the liquid, when testing has shown that adding titanium dioxide is not needed, and adding one to two kilograms of titanium dioxide to the liquid when testing has shown that it is needed;
twenty-fifth, flowing the liquid from the manifold to the ⅝ inch wide space between the photo-reactor plates, at a rate of up to 150 gallons per minute;
twenty-sixth, slowing and increasing liquid flow between the photo-reactor plates by the computer monitor; and
twenty-seventh, testing the liquid flowing out of the photo-reactor plates.

10. The method of claim 1, further comprising plugging a second end of the manifold with a cap.

11. The method of claim 1, further comprising joining multiple manifolds in a series with flexible tubing.

12. The method of claim 1, further comprising flowing the volatile organic compound laden waste water from the ⅝ inch wide space between the photo-reactor plates, at a rate of up to 150 gallons per minute, to a series of additional ⅝ inch wide spaces between additional 4 foot by 8 foot photo-reactor plates.

13. The method of claim 12, further comprising testing the volatile organic compound laden waste water as the volatile organic compound laden waste water moves between the photo-reactor plates.
